(19) United States
(12) Patent Application Publication
(10) Pub. No.: US 2012/0092884 A1
(43) Pub. Date: Apr. 19, 2012

(54) PROJECTION HEADLIGHT FOR MOTOR VEHICLES

(75) Inventors: Reinhard Dikau, Paderborn (DE); William Castéllon, Wadersloh (DE); Jörg Sudahl, Lippstadt (DE); Axel Röttinger, Erwitte (DE); Martin Wuller, Warendorf (DE); Daniel Süsselbeck, Lippstadt (DE); Thomas Hofmann, Erwitte (DE); Bastian Schwarz, Lippstadt (DE); Blanke Bjorn, Lippstadt (DE); Vikram Gaur, Lippstadt (DE); Brigitte Middelberg, Lippstadt (DE); Hendrik Rickmeyer, Lette (DE); Sonja Seibt, Warburg (DE); Sven Zehner, Frittlingen (DE)

(73) Assignee: Hella KG Hueck & Co., Lippstadt (DE)

(21) Appl. No.: 13/233,591

(22) Filed: Sep. 15, 2011

(30) Foreign Application Priority Data
Sep. 15, 2010 (DE) 102010045435.4

(51) Int. Cl. B60Q 1/04

(52) U.S. Cl. 362/538

(57) ABSTRACT

A projection headlight for motor vehicles has a reflector device, a plurality of light sources, at least one of said light sources assigned to the reflector device. A lens device is arranged in front of the reflector device in the main radiation direction. A cover device in the area of a focal point of the lens device has a cover shaft rotatable across the main radiation direction of the rotating axis main source. The cover shaft is provided with a number of glare edges and/or glare surfaces to adjust light distributors having a number of various cut-off lines. The light sources are arranged on a common light source carrier, the carrier extending substantially perpendicular to the main radiation direction and the carrier being configured to fasten onto a flat side of a heat sink.

### RELATED APPLICATIONS

This application claims priority and benefit of German Patent Application No. 102010045435.4, filed on Sep. 15, 2010, all of which is incorporated herein by reference.

### BACKGROUND OF INVENTION

1. Field of the Invention

The invention involves a projection headlight for motor vehicles with a reflector device, with at least one light source device assigned to the reflector device, and which is provided with a number of light sources, with one lens device assigned to the major radiating direction in front of the reflector device and with a cover arranged in the area of a focal point of the lens device; the cover has a turnable cover shaft running across the major radiating direction of the rotation axis, in which the cover shaft is provided with a number of glare edges and/or glare surfaces for setting up light distributors having a number of various cut-off lines.

2. Related Art

A headlight for motor vehicles is known from U.S. 7,540,638 B2, where the light module consists of a number of LED light sources and has a pre-stored lens. The LED light sources are arranged on an arc-shaped common switch carrier, on whose back side a heat sink is attached. The switch carrier is attached together with the heat sink to a horizontal bearing plate. Changing the LED light sources in this way is relatively expensive.

A projection headlight for motor vehicles is known from DE 10 2008 010 029 A1, which has a light source device, a reflector device, a cover, and a lens device pre-stored in the main radiation direction. The light source device has LED light sources, which are arranged across an optical axis or across the main radiation direction. The light is thus introduced to the reflector device vertically from above and/or vertically from below. To achieve a high light performance, two light source carriers and two separate heat sinks are necessary for the positioning of the LED light sources.

### SUMMARY OF THE INVENTION

The task of this invention is therefore to further develop a projection headlight for motor vehicles of a type that where there is little space an economical and simple assembly is assured, and where in addition an exchangeability of the components is assured, in particular of the light sources.

As a solution to this task, the invention, in connection with the preamble of patent claim 1, is so characterized in that the light sources are assigned to a common light source carrier, which extends perpendicular to the major radiation device and which can be fastened to a flat side of a heat sink.

The special advantage of the invention consists in the fact that in the preparation of the light stream, only a single light source carrier is necessary on which the light sources are arranged. Only a single heat sink must be assigned to the light source carrier. In this way the number of components is reduced, which leads to a simplified assembly and in particular to simplification of the electrical contact arrangements. In this way, since the light source carrier is attached to the heat sink, in cases of repair access to the light sources is achieved simply by detaching the heat sink.

According to a preferred embodiment of the invention, the light source carrier, the reflector device, and the heat sink form a common exchangeable modular unit, which is attached in a way that it can be detached from the frame that receives the cover and/or the lens device. Preferentially, in this way the exchangeable modular unit can be removed relatively simply from the projection headlight, so that for example in case of repair the light sources can be changed. The heat sink may have a form that supports the natural convection of the heated air. The heat sink can be set up in this relative space-saving manner.

According to a further embodiment of the invention, the cover and the lens device are arranged on a front side of the adjustable frame, and the reflector device and the light source device are arranged on a back side of the adjustable frame. It is advantageous here to have a basically constructed assembly of the projection headlight enabled, something that reduces the assembly expenditure.

According to a further embodiment of the invention, the light source switch carrier is created rigid and extends on a plane. It is advantageous in this way to support a simple adjustment of the reflector to various light source switch carriers. Further advantages of the invention result from the other dependent claims.

Further areas of applicability of the present invention will become apparent from the detailed description provided hereinafter. It should be understood that the detailed description and specific examples, while indicating the preferred embodiment of the invention, are intended for purposes of illustration only and are not intended to limit scope of the invention.

### BRIEF DESCRIPTION OF THE DRAWINGS

An embodiment of the invention will be further explained below with reference to the drawings.

The following is shown:

FIG. 1 An exploded presentation of a projection headlight,

FIG. 2 An exploded presentation of the major components of the projection headlight and

FIG. 3 A perspective presentation of an exchangeable modular unit removable from a frame of the projection headlight.

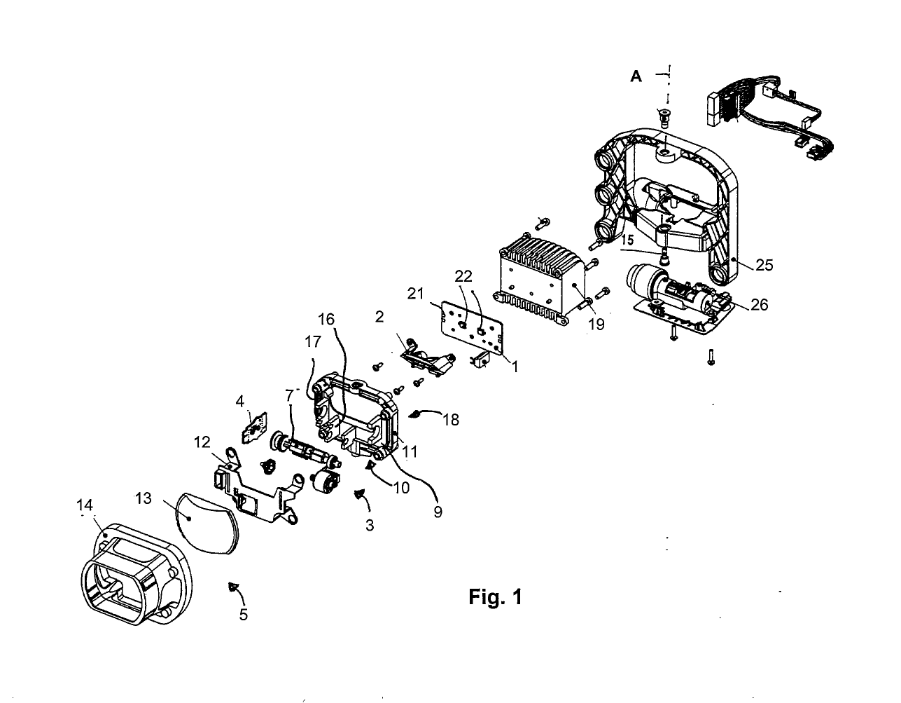

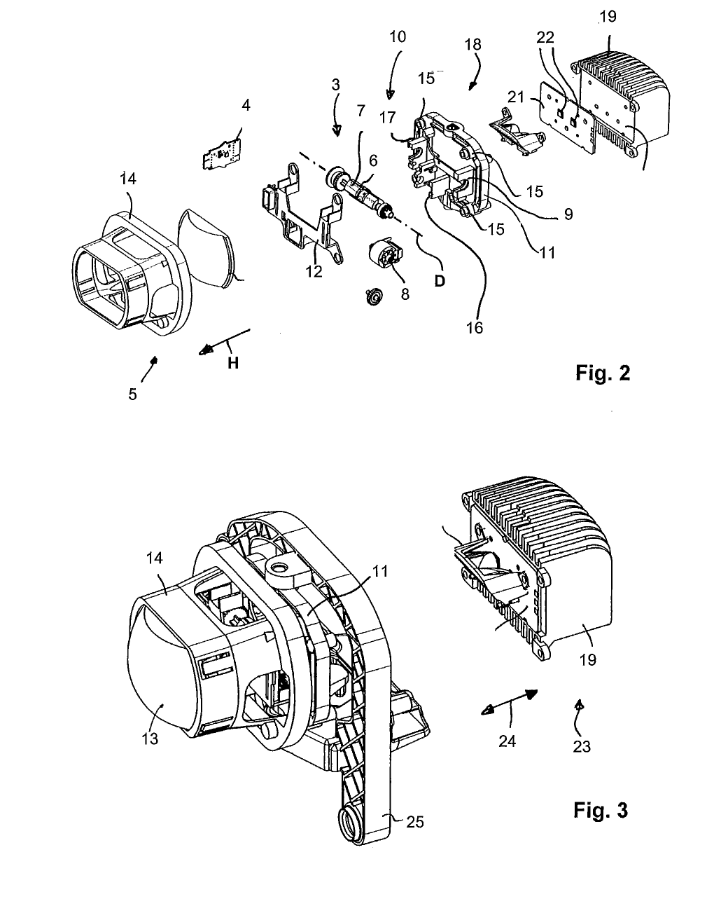

### DETAILED DESCRIPTION OF THE PREFERRED EMBODIMENT

A projection headlight for motor vehicles essentially consists of a light source device 1, a reflector device 2, a cover 3, and a lens device 5 arranged in the main radiation direction H in front of these devices.

The cover 3 is arranged in the area of a focal point of the lens device 5 and permits the projection of cut-off lines of various light diffusions (light figures) through the arrangement of several glare edges 6. For this, several glare edges 6 run in the lengthwise direction of a cover shaft 7 of the cover 3, whereby the cover shaft 7 is rotatable around a rotating axis D in the various activation turn positions by means of an electric motor 8.

The cover shaft 7 is stored in receptacles 9 on a front side 10 of an adjustable frame 11. A lower area of the front side 10 is covered by a covering element 12, which is fastened like a lens holder 14 bearing a lens 13, preferably detachable at the edge side attachment points 15 of the adjustable frame 11.

On the front side 10 of the adjustable frame 11, there is another receptacle 16 for the electric motor and a slit 17 for the reception of a sensor circuit board 4, planned to contain at least one sensor.

On a rear side 18 of the adjustable frame 11, seen in the main radiation direction H, this item is attached to a heat sink 19 by screwing at the attachment points 15. On one of the sides turned to the adjustable frame 11 or on a front side of the heat sink 19, this has a flat side 20, on which a light source carrier 21 is mounted. The light source carrier (LED switch carrier) 21 is formed level and rigid, and forms a circuit board for accepting the light sources formed as LED light sources 22 (LED chip). A reflector device 2 formed of a double reflector is fastened to a free front side of the light source carrier 21.

As is made clearer by FIG. 3, the light source device 1 and the reflector device 2 are fastened to the same heat sink 19, which is attached to the adjustable frame 11 through screwing at the attachment points 15. For purposes of repair, the projection headlight must merely be detached at the attachment points 15, so that an exchange unit 23 formed of the light source device 1, the reflector device 2, and a heat sink 19 can be taken out of the assembly position in the vehicle, and if necessary the LED light sources 22 can be changed. Disassembly or assembly of the exchange unit 23 preferably occurs in a linear direction—see arrow 24. In this way a simple and rapid exchange of the light sources 22 is assured.

The adjustable frame 11 is preferably in a carrier frame 25 and set rotatable around a vertical axis A, so that curved light readjustment or adaptive light adjustment is assured using control by an adjustment motor 26. The carrier frame 25 is attached to the chassis of the vehicle.

According to one embodiment of the invention that is not shown, the light source device has at least rows of many LED chips. For example, the row of LED chips may run straight or may depend on a light distribution or partial light distribution. Individual LED chips or groups of LED chips, in particular LED chips set out in a row, may be varied in their brightness, depending on the light function or the driving situation. For example, if two rows of LED chips exist, in which each row has 6 LED chips, a change in switching from rural road light function to highway light function may take place by dimming one row of LED chips.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A projection headlight for motor vehicles comprising:
a reflector device;
a plurality of light sources, at least one of said light sources assigned to the reflector device;
a lens device arranged in front of the reflector device in the main radiation direction;
a cover device in the area of a focal point of the lens device, having a cover shaft rotatable across the main radiation direction of the rotating axis main source;
said cover shaft being provided with a number of glare edges and/or glare surfaces to adjust light distributors having a number of various cut-off lines;
the light sources are arranged on a common light source carrier, said carrier extending substantially perpendicular to the main radiation direction; and
said carrier being configured to fasten onto a flat side of a heat sink.

2. The projection headlight according to claim 1, wherein the light source carrier and the reflector device together with the heat sink form an exchangeable unit, which is connected with and detachable from the bracket holding the cover and/or the lens device.

3. The projection headlight according to claim 1 wherein the frame is constructed as an adjustable frame, at least one of the cover or the lens device being attachable and detachable to or from said frame.

4. The projection headlight according to one of claim 1 wherein the light source carrier is structured as a single LED switch carrier.

5. The projection headlight according to one of claim 1, wherein the cover and the lens device are arranged on a front side of the adjustable frame, and the reflector device and the light source device are set up on a back side.

6. The projection headlight according to one of claim 1 wherein a lens holder of the lens device and the heat sink are connected with the adjustable frame, each on opposite sides of the adjustable frame, by screwing into the same fastening points.

7. The projection headlight according to one of claim 1 wherein the cover has a cover shaft turnable about a horizontal rotation axis with a number of glare edges running in the lengthwise direction of the cover shaft for the creation of various light distributions.

8. The projection headlight according to one of claim 1 wherein the cover shaft is stored in a receptacle of the adjustable frame.

9. The projection headlight according to one of claim 1 wherein the light sources are formed as LED light sources, which are arranged on the plane of a rigid light source carrier.

10. The projection headlight according to one of claim 1 wherein the adjustable frame is turnable around a vertical rotation axis in a carrier frame.
